(19) United States
(12) Patent Application Publication
(10) Pub. No.: US 2008/0252219 A1
(43) Pub. Date: Oct. 16, 2008

(54) IGNITION CONTROL DEVICE

(75) Inventors: DEYOU LEI, Shangyu City (CN); Jiangang DONG, Shangyu City (CN)

Correspondence Address: DORITY & MANNING, P.A., POST OFFICE BOX 1449, GREENVILLE, SC, 29602-1449, US

(73) Assignee: SHAO XING FENGLONG ELECTRICAL MACHINERY CO., LTD., ZHEJIANG PROVINCE (CN)

(21) Appl. No.: 12/098,536

(22) Filed: Apr. 7, 2008

(30) Foreign Application Priority Data
Apr. 13, 2007 (CN) CN200720068964.5
Jan. 31, 2008 (CN) CN200820006060.4

(51) Int. Cl. F02P 15/00

(52) U.S. Cl. 315/119; 123/640

(57) ABSTRACT

The invention provides an ignition control device and a killing control device correspond. An ignition control device comprises an ignition circuit module and a killing control device corresponds. The ignition circuit module comprises a killing control device including a killing switch and a timing retard circuit module connected to the ignition circuit module. When the killing control operates, the ignition circuit stops igniting. The invention has following advantages: reasonable structure, low cost, stable control circuit and safe operation and so on.

### TECHNIC FIELD

The invention relates to an ignition control device, specially to an ignition control device with a killing control device correspond.

### BACKGROUND

A micro engine such as a gas engine which working process is shown as in FIG. 1 is usually used to a micro machine such as a trimmer and so on. The existing micro engine is usually rotated by the outside force. The coil produces a voltage driving the ignition circuit module of the ignition control device by induction after the coil cutting the magnetic lines of force. The engine ignites and works after the ignition circuit module outputs high voltage. When the machine need be closed, the power of the ignition circuit module is shorten after actuating the killing switch, then the engine stops igniting so that the rotate speed changes from high to low until fully stop.

In prior art, the ignition control device may be set on the normal ready state once cutting the killing switch, since the power of the ignition circuit module is shorten and grounded directly after turning on the killing switch. Then when working, there exits more serious danger because the engine may be in low rotate speed when the ignition control device recovers the normal work state so that the ignition control device start again. The killing coil is also used to send the signal to the killing circuit in prior art, but it has some disadvantages such as complicated manufacture, unstable quality, inferior security and high cost and so on.

### SUMMARY OF THE INVENTION

The object of the invention is providing an ignition control device and a killing control device correspond with reasonable structure, low cost, reliable control circuit and safe operation.

To achieve said object, the invention provides the following technique design.

An ignition control device comprises an ignition circuit module and a killing control device corresponds. The ignition circuit module comprises a killing control device including a killing switch and a timing retard circuit module connected to the ignition circuit module. When the killing control operates, the ignition circuit stops igniting. The engine rotates by the outside force and drives the ignition circuit module of the ignition control device through the induction of the coil. Then the engine is ignited and starts to working after the ignition circuit module outputting the high voltage. After actuating the killing switch of the killing control device, the ignition circuit module stops outputting the ignition voltage immediately and the engine stops igniting when the killing control device operates.

The timing retard circuit module of the killing control device comprises at least one level charge circuit module. The level of the charge circuit may be set to two levels or more corresponding to the rotate speed of the engine. By selecting the different levels, the time of the ignition circuit without ignition voltage may be controlled so as to the engine is in fully stopping state. The killing switch of the killing control device is arranged on the location suitable for operation. The timing retard circuit module of the killing control device further comprises a voltage division module providing the turn-on voltage of the transistor Q3 to decrease the input impedance and improve the anti-interfere ability. The killing control device further comprises a diode to protect the transistor Q3 when working.

The parameters of the capacitors and the resistances of the timing retard circuit module may be regulated to meet the need for timing retarding. The capacitance range of the capacitor C2 of the killing control device is 0.68 uF˜22 uF. The capacitance range of the capacitor C3 is 10 uF˜50 uF. The resistance range of the resistor R8 is 30 KΩ-300 KΩ). The resistance range of the resistor R9 is 90 KΩ-300 KΩ.

The invention has following advantages comparing with the prior art: 1. simply manufacture, low cost and stable quality; 2. the engine may be in fully stopping state to ensure the safety of the engine operation; 3. the ignition circuit of the ignition control device may autorecover and the engine is autorecovered to ready-to-start state.

### BRIEF DESCRIPTION OF THE DRAWINGS

FIG. 1 is a working flow diagram of the prior art;

FIG. 2 is a working flow diagram of the present invention;

FIG. 3 is a schematic view of the present invention;

FIG. 4 is a circuit schematic view of an embodiment of the present invention;

FIG. 5 is a circuit schematic view of another embodiment of the present invention;

FIG. 6 is a schematic view of an application of the present invention;

FIG. 7 is a schematic view of another application of the present invention.

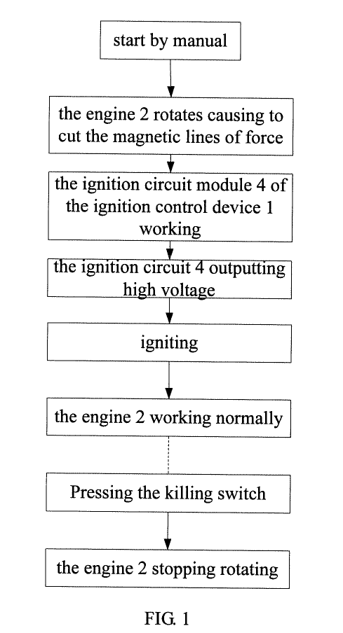

### DETAILED DESCRIPTION

The embodiments of the invention will be detailedly explained referred to the drawings.

Referring to the drawings, the invention starts to work corresponding to the followings: when the operator need to start the engine 2, the engine 2 rotates to cause magnetic lines of force cutting the coil by outside force, then the ignition circuit module 4 of the ignition control device 1 starts to work by the induction of the coil L2 and sends the high voltage to the engine 2 through the high voltage line 7 so that the engine 2 may be ignited and start to work normally; when the operator need to stop the engine, then killing switch K1 is actuated, the killing control device 3 starts to work while the ignition circuit module 4 stops outputting the ignition voltage immediately and then engine 2 isn't ignited; after the killing switch is unactuated, there exists at least one level charge circuit 5 between killing switch K1 and ground, so the ignition circuit 4 is still in no ignition voltage output state until the voltage discharge of the capacitor in the charge circuit 5 ends. At the same time, the engine 2 has fully stopped and closed safely.

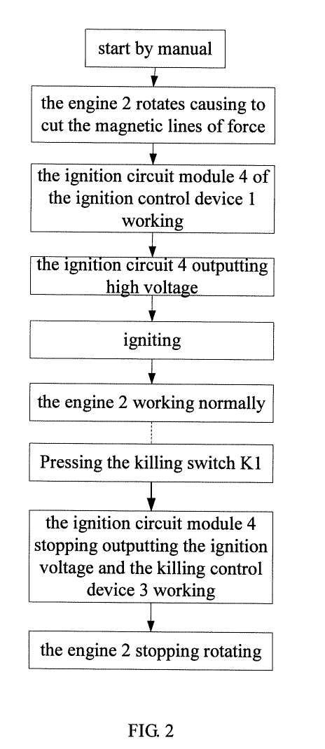

As shown in FIG. 2, the killing switch K1 may arranged on any location suitable for operating such as the handle of the trimmer in the present invention.

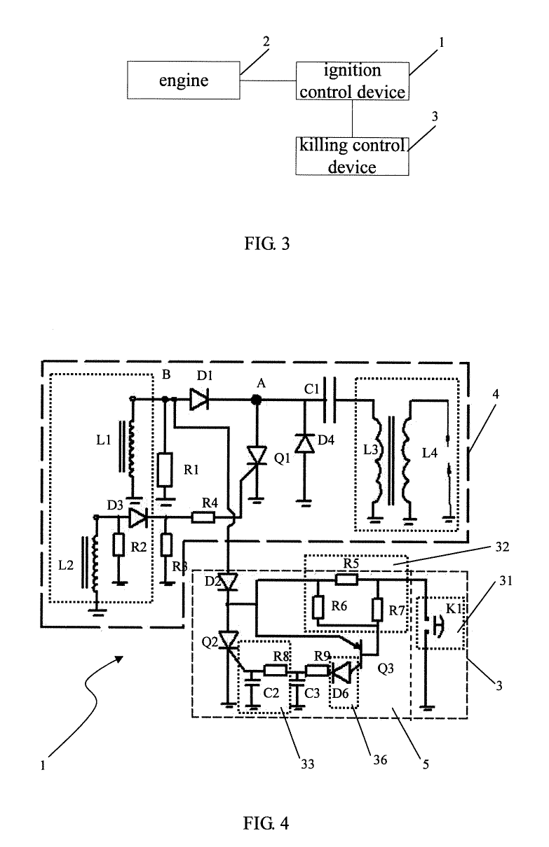

As shown in FIG. 3, the engine 2 comprises an ignition control device 1 including an ignition circuit module 4. The invention further comprises a killing device 3 connected to the ignition device 1, wherein the timing retard circuit module 5 is connected to the ignition circuit module 4.

The circuit shown in FIG. 4 comprises an ignition circuit module 4 and a timing retard circuit module 5. Said ignition circuit module comprises an induction module and a transformer output module. Said induction module comprises a charge coil L1 and a trigger coil L2. When the engine 2 is rotating and the coil is cutting the magnetic lines of force, said induction module sets the ignition circuit module into work state through electromagnetic induction. Said transformer output module comprises a primary coil L3 and the ignition circuit outputs high voltage through the coil L4.

The ignition circuit module 4 shown in FIG. 4 further comprises a diode D1, a diode D2, a diode D3, a diode D4, a resistor R1, a resistor R2, a resistor R3, a resistor R4, a SCR Q1, a capacitor C1 and a transformer. A node A is set among the diode D1, the capacitor C1 and the SCR Q1. The anode of the SCR Q1 is connected to the node A and the cathode is grounded. The gate of the SCR Q1 is connected to one side of the resistor R4, the other side of the resistor R4 is connected to the cathode of the diode D3. One end of the resistor R3 is connected between the resistor R4 and the diode D3 and the other end is grounded. One end of the resistor R2 is connected to the anode of the diode D3 and the other end is grounded. The anode of the diode D3 is connected to one side of the trigger coil L2 and the other side of the trigger coil L2 is grounded. At the same time, the node A is connected to one side of the capacitor C1. The other side of the capacitor C1 is grounded through the primary coil L3 of the transformer. The anode of the diode D1 is connected to one side of the charge coil L1 and the other side of the charge coil L1 is grounded. Where the anode of the diode D1 is connected to the charge coil L1 is a node B. One end of the resistor R1 is connected to the node B and the other end is grounded. The cathode of the diode D4 is connected to the node A and the anode is grounded.

The timing retard circuit module 5 shown in FIG. 4 further comprises a killing switch K1, the diodes D2 and D6, SCR Q2, an transistor Q3, the capacitors C2 and C3, the resistors R5, R6, R7, R8 and R9. The anode of the diode D2 is connected to the backend of the charge coil L1. The cathode of the diode D2 is connected to the anode of the SCR Q2, the emitter of the transistor Q3, one end of the resistor R5 and one end of the resistor R6, respectively. The other end of the resistor R6 and one end of the resistor R7 are connected to the base of the transistor Q3. The other end of the resistor R5 is connected to the other end of the resistor R7. One end of the killing switch K1 is connected to the point where the resistor R5 connected to the resistor R7 and the other end is grounded. One end of the resistor R8 is connected to the gate of SCR Q2 and the other end is connected to one end of the resistor R9. The other end of the resistor R9 is connected to the cathode of the diode D6. The anode of the diode D6 is connected to the collector of the transistor Q3. One end of the capacitor C2 is connected between the resistor R8 and R9 and the other end is grounded. One end of the capacitor C3 is connected between the resistor R9 and the diode D6 and the other end is grounded.

The timing retard circuit module 5 comprises a charge circuit module 33 including the capacitors C2 and C3 as well as the resistor R8 and R9 to achieve the timing retard. The timing retard circuit module 5 further comprises a voltage division module 32 providing the turn-on voltage of the transistor Q3 to decrease the input impedance and improve the anti-interfere ability. The killing control device 3 further comprises a diode to protect the transistor Q3 when working. The killing control device 3 further comprises a switch.

The level of the charge circuit of the charge circuit module 33 shown in FIG. 4 may be set to one level, two levels or more corresponding to the rotate speed of the engine. The time for the ignition circuit without the ignition voltage output may be controlled so that the engine is fully stopped through selecting the different levels.

The parameters of the capacitors and the resistors of the charge circuit module 33 shown in FIG. 4 may be regulated to suit to the timing retard. The capacitance range of the capacitor C2 of the ignition control device is 0.68 uF˜22 uF. The capacitance range of the capacitor C3 is 10 uF˜50 uF. The resistance range of the resistor R8 is 30 KΩ-300 KΩ. The resistance range of the resistor R9 is 90 KΩ-300 KΩ.

The parameters of the capacitors and the resistors of the charge circuit module 33 shown in FIG. 4 may be regulated to suit to the timing retard. For example, when C2=1 uF, C3=22 uF, R8=91 KΩ, R9=91 Kω, the timing retard is 3.5 S when the rotate speed of the engine 3000 r/min, the timing retard is 5 S when the rotate speed of the engine 8000 r/min.

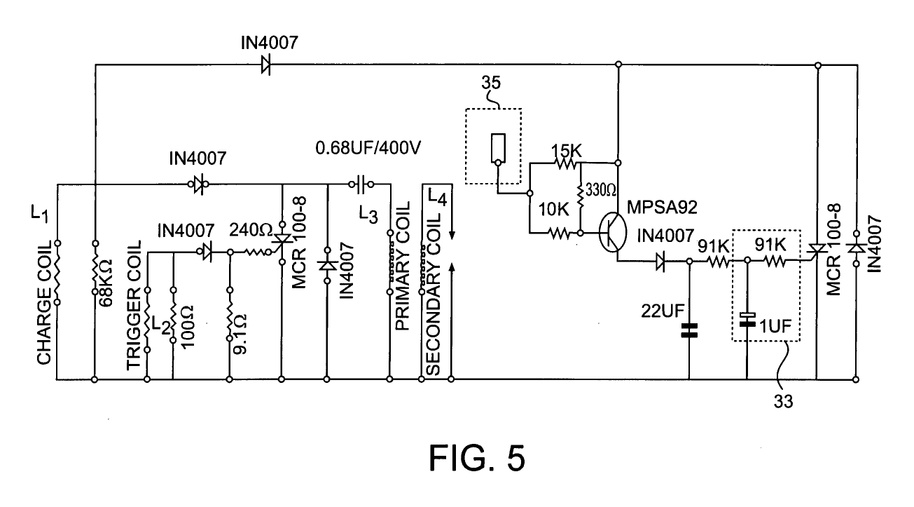

FIG. 5 is a circuit schematic view of another embodiment of the present invention which working principle is same as in FIG. 4. The components in FIG. 5 are essentially same as the FIG. 4 so that the type and the parameters of the components may refer to that in FIG. 5. The difference between FIG. 5 and FIG. 4 is that the switch isn't shown in FIG. 5.

The level of the charge circuit of the charge circuit module 33 shown in FIG. 5 may be set to one level, two levels or more corresponding to the rotate speed of the engine. The time for the ignition circuit without the ignition voltage output may be controlled so that the engine is fully stopped through selecting the different levels.

In the module 35 shown in FIG. 5, one end of the killing piece is connected to a switch. The other end of the switch is grounded.

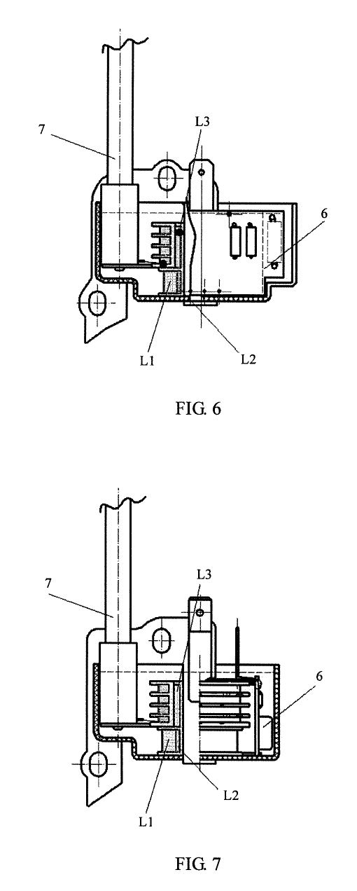

FIG. 6 is a schematic view of an application of the present invention comprising a high voltage line 7, a control circuit board 6, a killing control device 3, a charge coil L1, a trigger coil L2 and a primary coil L3. The control circuit board 6 is installed on the face of said ignition device. The part of the ignition control, the trigger coil L2 and the charge coil L1 compose a ignition circuit 4. The killing control device 3 comprises a timing retard circuit 5.

FIG. 7 is a schematic view of another application of the present invention, wherein the ignition control device 1 and the control circuit board also may be set at the right of said ignition device.

As the embodiments of the present invention have been described above, it should be understood that the present invention is not limited to the above specific embodiments. Various modifications or alterations can be made by those skilled in the art without departing from the scope as defined by the appended claims.

1. An ignition control device comprises a ignition circuit module that further comprises a killing control device.

2. The ignition control device according to claim 1, wherein the killing control device includes a killing switch and a timing retard circuit module, said timing retard circuit module is connected to the ignition circuit module; when the killing control device operates, the ignition circuit stops outputting the ignition voltage.

3. The ignition control device according to claim 2, wherein the timing retard circuit module comprises at least one level charge circuit module.

4. The ignition control device according to any one of claims 1-3, wherein the level of the discharge circuit may be set to at least two levels corresponding to the rotate speed of the engine.

5. The ignition control device according to claim 4, wherein the level of the discharge circuit may be set to at least three levels corresponding to the rotate speed of the engine.

6. The ignition control device according to claim 3, wherein the timing retard circuit module of the killing control device further comprises a transistor and a voltage division module providing the turn-on voltage of the transistor to decrease the input impedance and improve the anti-interfere ability.

7. The ignition control device according to claim 6, wherein the killing control device further comprises a diode to protect the transistor when working.

8. The ignition control device according to any one of claims 1-7, wherein the killing control device comprises a killing switch, a pair of diodes, silicon controlled rectifier (SCR), a transistor, a pair of capacitors, a quintet of resistors and a charge coil; the anode of a first one of the diode pair is connected to the backend of the charge coil; the cathode of the first diode is connected to the anode of the SCR, the emitter of the transistor, one end of a first one of the resistor quintet and one end of a second one of the resistor quintet, respectively; the other end of the second resistor and one end of a third one of the resistor quintet are connected to the base of the transistor; the other end of the first resistor is connected to the other end of the third resistor; one end of the killing switch is connected to the point where the first resistor is connected to the third resistor and the other end is grounded; one end of the a fourth one of the resistor quintet is connected to the gate of SCR and the other end of the fourth resistor is connected to one end of a fifth one of the resistor quintet; the other end of the fifth resistor is connected to the cathode of a second one of the diode pair; the anode of the second diode is connected to the collector of the transistor; one end of a first one of the capacitor pair is connected between the fourth resistor and the fifth resistor and the other end of the first capacitor is grounded; one end of a second one of the capacitor pair is connected between the fifth resistor and the second diode and the other end of the second capacitor is grounded.

9. The ignition control device according to claim 7, wherein the parameters of each capacitor and each resistor may be regulated to suit to the timing retard.

10. The ignition control device according to claim 8, wherein the capacitance range of the first capacitor of the ignition control device is 0.68 uF˜22 uF, the capacitance range of the second capacitor is 10 uF˜50 uF, the resistance range of the fourth resistor is 30 KΩ-300 KΩ and the resistance range of the fifth resistor is 90 KΩ-300 KΩ.
